(19) United States
(12) Patent Application Publication
(10) Pub. No.: US 2019/0246149 A1
(43) Pub. Date: Aug. 8, 2019

(54) PROTECTED MULTIMEDIA CONTENT TRANSPORT AND PLAYBACK SYSTEM

(71) Applicant: PCCW VUCLIP (SINGAPORE) PTE. LTD., SINGAPORE (SG)

(72) Inventors: Areef Reza, San Jose, CA (US); Mark Li, San Jose, CA (US); Bo Shen, Fremont, CA (US)

(21) Appl. No.: 15/892,394

(22) Filed: Feb. 8, 2018

(51) Int. Cl. H04N 21/2347; G06F 21/60; G06F 17/30; H04N 21/258; H04N 21/8549; H04N 21/239; H04N 21/61

(52) U.S. Cl. CPC H04N 21/2347; G06F 21/602; G06F 17/30858; H04N 21/6125; H04N 21/8549; H04N 21/2393; H04N 21/25841

(57) ABSTRACT

A multimedia content distribution system creates and distributes content files that contain content that may be viewed or displayed using commonly distributed viewer or player programs. A second portion of the content files may be viewed using specialized viewer or player programs.

### TECHNICAL FIELD

Embodiments relate generally to electronic content publishing, and, more specifically, to techniques for securely encapsulating secondary audio or video content in a video file.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Online content distributors publish a variety of media content items to consumers. Published content items may range from amateur, user-uploaded video clips to high-quality television shows and movies. A content distributor publishes a content item by making the content item available electronically to client computing devices through one or more access mechanisms known as channels or sites. Such sites may include different web sites, web applications, mobile or desktop applications, online streaming channels, and so forth. A site may be hosted by the content distributor itself, or by another entity, such as an Internet Service Provider or web portal. A site may freely publish a content item to all client devices, or impose various access restrictions on the content item, such as requiring that the client device present credentials associated with a valid subscription that permits access to the content item, or requiring that the client device be accessing the site through a certain provider or within a certain geographic area.

A content distributor may distribute media content items produced by other entities, referred to herein as content providers. A content distributor may publish content that the distributor has stored within its own system on behalf of the content provider. For instance, if the content item is a video, the content provider may send a video file to the content distributor, and the content distributor may store and optionally process the video file for various purposes. The content distributor may then publish the content item from this location through its own servers. Or, the content distributor may publish a content item by publishing a link through which a consumer retrieves the content item from a location at which the content item is hosted by the content provider or another suitable entity.

Security or copyright protection is generally a concern for many content distributors. This typically involves protecting the content items using some type of encryption schema prior to publishing the content items. The drawback to encrypting content items that are downloaded to client devices is that client devices must use a proprietary player in order to decrypt the content items and to subsequently playback the content items to users. This limits the viewership of the content items to users that have subscribed to the services provided by the content distributors. This also severely limits the exposure of content items published by the content providers to users that are not subscribed to the services - users must commit to a service provided by a content distributor before being able to preview or partially view a particular content item. Another drawback is that the distribution of a proprietary player requires user acceptance, for example, users do not want to commit to a service or service trial by downloading a proprietary player. This is further exacerbated when users are unable to preview content items without downloading the proprietary player.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an embodiment of the invention;

FIG. 2 is a block diagram of a content file having an active content area and a shadow content area, according to an embodiment;

FIG. 3 is an illustrative view an MP4 file that includes a shadow video area, according to an embodiment;

FIG. 4 is an illustrative view an MP4 file that includes a shadow video area using the user data area, according to an embodiment;

FIG. 5 is an illustrative view an MP4 file that includes a shadow video link, according to an embodiment;

FIG. 6 is an illustrative view an MP4 file that includes a shadow video link using the user data area, according to an embodiment;

FIG. 7 is a block diagram of a shadow SDK integration with a player, according to an embodiment;

FIG. 8 is a block diagram of a shadow SDK integration with a video delivery infrastructure, according to an embodiment;

FIG. 9 is a block diagram of a shadow SDK creating a content file, according to an embodiment;

FIG. 10 is a block diagram of a sharing content files having shadow content, according to an embodiment;

FIG. 11 is a block diagram of an online shadow content system, according to an embodiment; and

FIG. 12 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1.0. General Overview

2.0. Structural Overview
2.1. Video Delivery System
2.2. The Content Container
2.3. Metadata for Shadow Video
2.4. Shadow SDK Integration with a Video Player
2.5. Creating a Shadow Container from a Downloaded Video
2.6. P2P Sharing
2.7. Online Shadowing
2.8. Shadow Applications
   2.8.1. Automatic Extraction
2.9. Monetizing Shadow Content

3.0. Implementation Mechanism—Hardware Overview

4.0. Extensions and Alternatives

### 1.0. General Overview

This overview presents a basic description of some aspects of possible embodiments of the present invention. It should be noted that this overview is not an extensive or exhaustive summary of aspects of the possible embodiment. Moreover, it should be noted that this overview is not intended to be understood as identifying any particularly significant aspects or elements of the possible embodiments, nor as delineating any scope of any possible embodiment in particular, nor the invention in general. This overview merely presents some concepts that relate to the example possible embodiment in a condensed and simplified format, and should be understood as merely a conceptual prelude to a more detailed description of example possible embodiments that follows below.

There are a very large number of content providers and third-party content providers. These providers provide many types of content, for example, music, books, news, video, games, etc., to users across the Internet. In order to protect the content from copying or unauthorized access, content providers will typically encrypt or format the content files. The proprietary encryption or formatting securely protects the content files, but requires that the content providers distribute proprietary viewers and players to users in order to view or play the content. The proprietary viewers and players can decrypt the content files and/or have the ability to understand the formatting of the content files. Proprietary viewers and players offer the added benefit of being able to monitor user viewing patterns and habits, track content preferences, present advertisements, suggest related content, present trending content, etc. One of the drawbacks to proprietary viewers and players is that the content is not easily distributed or desired to be distributed by third party providers because the distribution of the proprietary viewers and players is not under the third party's control.

An embodiment of the invention provides a solution to these problems by creating a content file that may be played by any standard, commonly distributed, viewer or player, yet contains content or a link, e.g., a URL, etc., to a content file that can require a proprietary viewer or player to view or play. A content file is created that contains two content areas. The first content data area is accessible to standard viewers and players. The second content data area is only accessible to proprietary applications such as proprietary viewers and players. This “shadow” content appears as excess data in the content file. A standard viewer or player loads the content file and plays the first data area as if it were a normal file, e.g., MP4, MP3, MKV, 3GP, AVI, etc. The user interacts with the standard viewer or player as one would normally do so. The first content data area may be any multimedia content, e.g., video, audio, text, spreadsheet, etc., that can be presented to a user. The content being viewed or played by the user may make some reference to the existence of further or related content and that another viewer or player is available that can access such content, possibly supplying a link to the viewer or player.

The user may download the proprietary viewer or player and then direct the viewer or player to the content file. The viewer or player accesses the second content data area in the content file and displays the content to the user. The content in the second content data area may contain any multimedia content, e.g., video, audio, text, spreadsheet, etc., that can be presented to a user. The purpose of the second content data may be to provide full-length videos, director cut videos, detailed spreadsheets, extended play music, lectures, reference materials, books, audio narration, etc.

This approach allows the content files to be distributed by third party servers without any need of the third party servers supplying specialized players. The embodiments described herein make the distribution of content files to third party servers more efficient and straight-forward because standard programs can play or display a portion of the content files without the need of specialized viewers or players.

Another embodiment creates a content file that may be played by any standard viewer or player and contains a link, e.g., a URL, etc., in the second content data area that points to a web page or portal where a user may view or play a content file, play a game, etc.

In yet another embodiment, an extractor module can automatically extract an application from the second content data area or retrieve an application from a source based on an evaluation of the content contained in the second content data area. The extractor module may be installed onto the client device or may exist in the first content data area and be installed locally upon viewing or playing content, such as a teaser, etc., from the first content data area. The extractor executes and evaluates the content in the second content data area and decides whether the content can be installed onto the client device or whether the content requires a particular application that consumes the content. The application can be any program, e.g., a proprietary viewer or player, game kernel, word processor, presentation program, spreadsheet program, etc. The application consumes data from the second content data area to view, play, etc.

### 2.0. Structural Overview

2.1 Video Delivery System

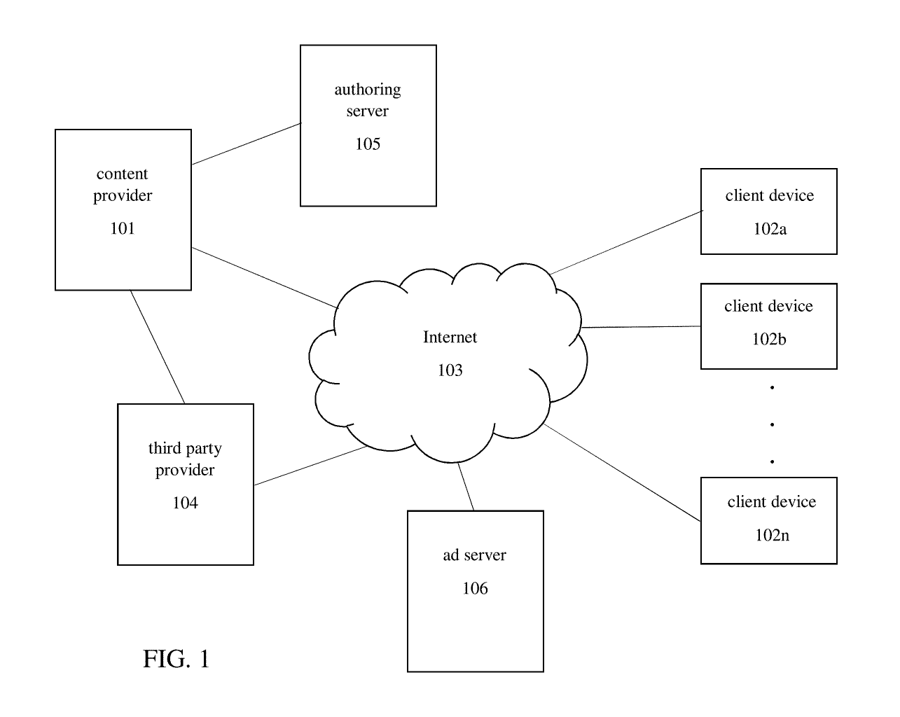

Referring to FIG. 1, a content provider server 101 may consist of many servers such as in one or more server farms. The content provider server 101 distributes content to multiple client devices 102a-n. An embodiment provides an effective content delivery solution that enables Digital Rights Management (DRM) based security that protects content from illegal reproduction/distribution. The content provider server 101 may monetize the content either by distribution and views of video ads inserted in the video content or by directly charging users (e.g., per viewing/access, for a continuing service, etc.). The client devices 102a-n send the content provider server 101 analytics data that tells the content provider which content is selected, when content is viewed or played, when a section of content is fast-forwarded or rewound through, when and where trick play functions are used in the content (e.g., pause, frame step, slow play, etc.), etc. The content provider server 101, either thru the content server 101 or via an account server (not shown), can track and report performance and viewing analytics using the analytics data. The reports can be viewed by content provider administrators, advertising customers, etc., that inform them about how often the content was consumed, which ads were viewed, which portions of content are the most popular, etc.

In an embodiment, the client devices 102a-n may have a specialized viewer or player (herein referred to as player) installed that implements appropriate DRM security mechanisms implemented in the content files. The player has the ability to interact with an appropriate ad server 106 and pull fresh video ads when playing the content. The ads may be in the form of audio content, video content, text content, etc. The player also generates analytics events during the viewing or playback of the content. The player sends the analytics events to the content provider server 101.

In an embodiment, in a video content example, an authoring server 105 or the content provider server 101 places a preview or a trailer video of the original video content along with the original video content into one video container or content file which can be played by any standard video player. A standard player can only play the trailer video and is completely unaware of the original video which remains protected in the content file. In an embodiment, the preview or trailer video can include instructions on how to obtain a supported player that can play the original video content.

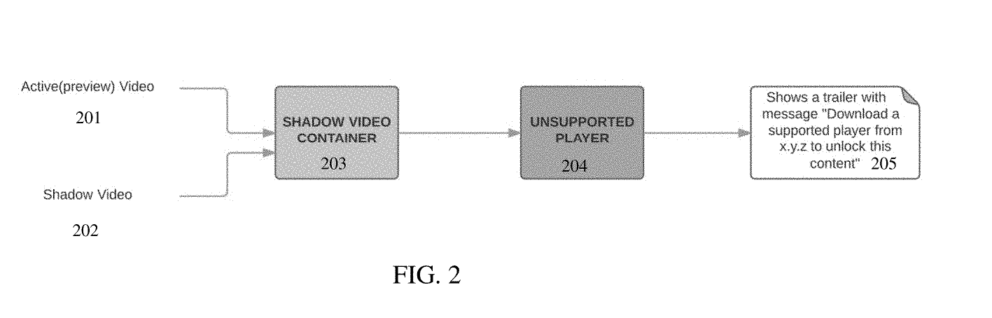

Referring to FIG. 2, in an example, the preview or trailer video is the active video 201 and the original video is the “shadow” video 202; both are contained in a common video file 203. The video file 203 may be distributed to end users' client devices 102a-n via typical distribution channels through a content provider server 101 or third party server 104, e.g., a web site, email, communication channels, torrent sites, social sites, etc. Users then play the video file using a standard video player 204 where only the active video plays. The active video also displays a textual or graphical message 205 indicating a URL where the user can download a specialized player that unlocks the shadow content in the video file and allows the user to view the entire premium content in the shadow video. The user may then visit the URL and download the specialized player to the client device 102a-n or may access the specialized player remotely, e.g., in the cloud, etc. The specialized player executes and is directed to the video file either automatically from the user clicking on the URL or by the user. The player detects that the video file includes a shadow video and directly plays the shadow video. Before and during the playback of the shadow video, the player can perform the DRM security, monetization, and analytics activities discussed above.

In another example, an active content may be included in a content file that includes text of excerpts from a novel along with shadow content that includes the entire novel. A standard viewer may be able to display the excerpts in the active content and cannot access the shadow content. The active content may also include instructions and/or a link (e.g., a URL, etc.) that allows the user to install or access a specialized viewer that can access the novel in the shadow content.

In yet another example, the shadow content may contain detailed spreadsheets while the active content may contain spreadsheets with limited data. A standard spreadsheet program will only be able to access the spreadsheets in the active content. The user must install or access a specialized spreadsheet program that can access the detailed spreadsheets in the shadow content.

In a further example, the shadow content may contain audio content while the active content may contain an audio preview that relates to the audio content. The audio preview may also include instructions to the user on how to obtain a specialized player that can access the audio content in the shadow content. Once the specialized player is accessed, the audio content may be played to the user.

2.2 The Content Container

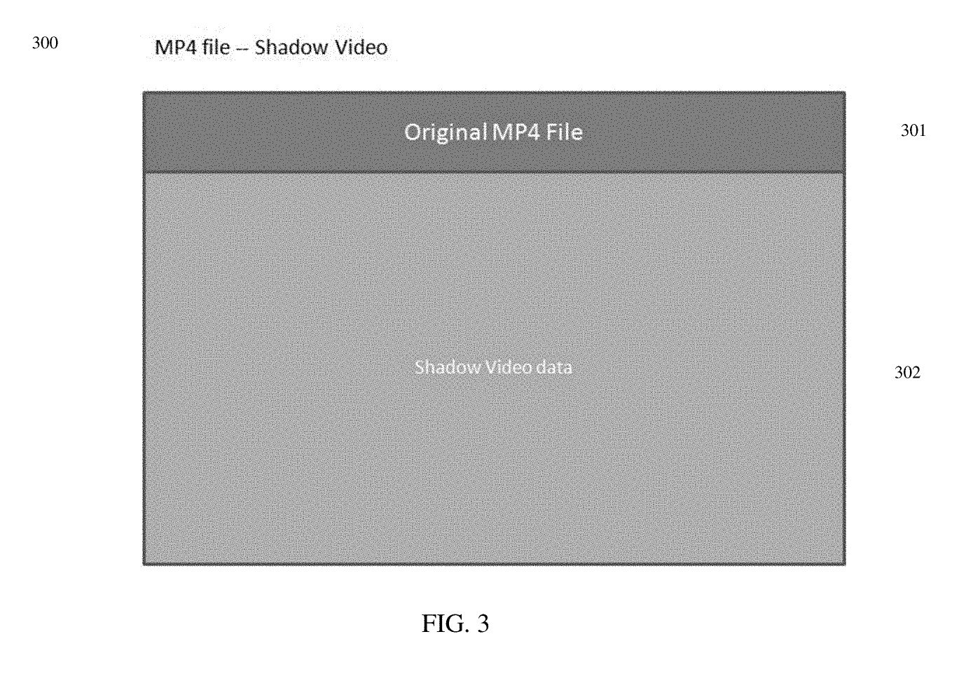

In an embodiment, because, in the video example, the content file is playable on any standard player, the container can be implemented using a standard format, e.g., MP4, MP3, 3GP, AVI, MKV, etc. Note that, although video formats are discussed in the following, any audio, textual, presentation, multimedia, etc., format may be used in alternate embodiments. The shadow video may be added to the content file which can be played by a specialized video player, very much like a local video. For example, referring to FIG. 3, in an MP4 format, the active video is added to the content file 300 in a typical video data area 301 and the shadow video is added to the content file 302 after the active video 301. The specialized player may index into the content file to play the shadow video using a pointer that may be included in metadata for the content or may jump to the shadow video using any other addressing scheme. The shadow video format can be encoded as a standard locally playable video file such as MP4, MP3, 3GP, MKV, AVI, etc. In an embodiment, the specialized player may reference a field in the content file data structure to obtain an offset or pointer to the shadow video. The offset or pointer may be located in any of: an unused tag, another video tag, or a reserved tag, in the content file data structure.

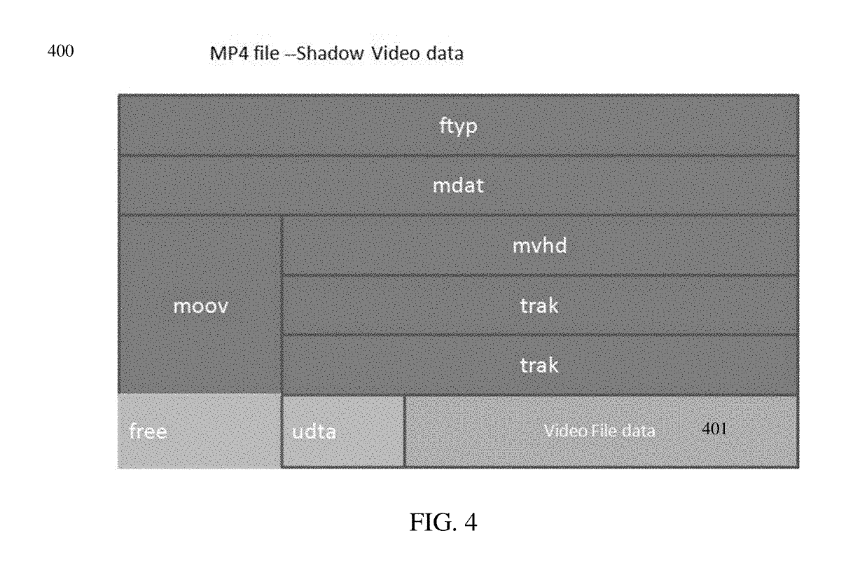

Alternatively, referring to FIG. 4, in an MP4 format the shadow video is added to the content file 400 in the user data area 401. The specialized player can refer to the udta area of the content file and play the shadow video.

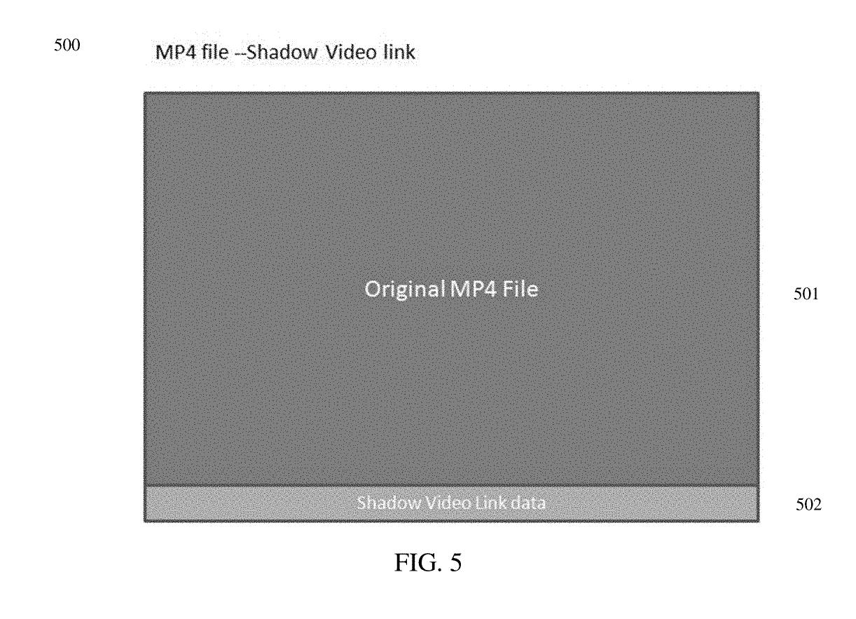

Rather than including the entire shadow video into the content file, an embodiment can include a link to the shadow video in the content file. For example, referring to FIG. 5, in an MP4 format, the active video is added to the content file 500 in the typical area 501 and a link to the shadow video 502 is added after the active video 501. The specialized video player may then play the shadow video using the link 502 to access a remote site and directly stream the shadow file from the remote site. The shadow video can be encoded in a standard streamable format such as HLS, MPEG-DASH, etc., which includes all the necessary manifest and data files.

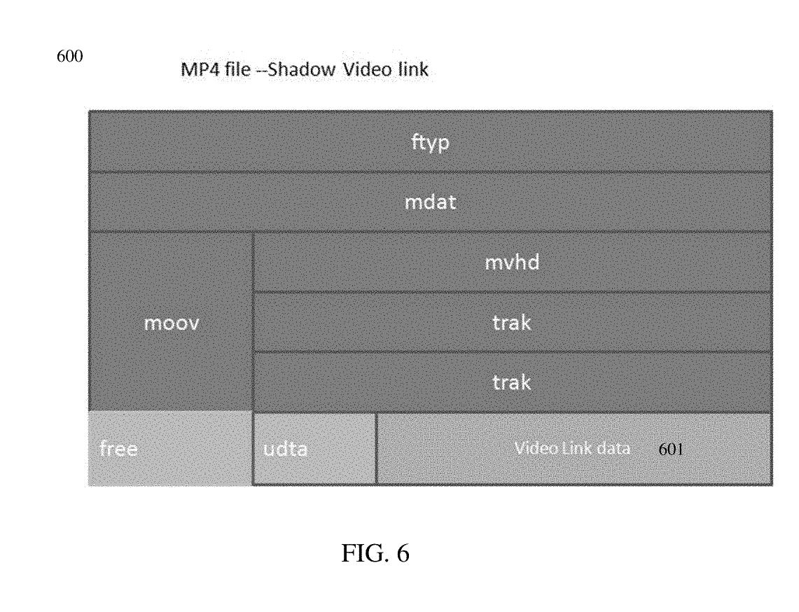

Alternatively, referring to FIG. 6, in an MP4 format the shadow video is added to the content file 600 in the user data area 601. The specialized player can refer to the udta area of the content file to retrieve the link and stream the shadow video from the remote site.

Alternatively, the shadow video can also be a composition of standard video, subtitles, image thumbnails, arbitrary metadata, etc. or any text, audio, textual, presentation, multimedia, etc., format.

The content file as discussed above represents a valid video file that can be played by any video player that supports standard video formats, for example, MP4 with h.264+aac codecs, etc. In an embodiment, the shadow video may be protected using encryption techniques and/or other DRM techniques. In an embodiment, a portion or more of the shadow video may be encrypted. In an embodiment, the portion of the shadow video that is encrypted may contain a digital key that allows access to the shadow video. The specialized player may access the shadow video using decryption techniques and/or other DRM techniques.

As discussed above, the active video may be a preview of the shadow content and may also display a link to download a specialized player to play the shadow content. The download link displayed in the active video can perform any of the following actions:

i) When the link is loaded on a mobile browser, it can directly take the user to an app play store, e.g., Google Play Store, Apple iTunes, etc., for the supported player installation, or

ii) When the link is loaded on a desktop or a mobile browser, it can take the user to a supported browser-based player site and the content is played, for example, from the content provider's server 101, a third party server 104, peer client device 102a-n, etc. In addition to such browser-based playback, the site can also display an appropriate player download link where the user can download the player when local player execution is desired over web site delays.

In an embodiment, the content file may include a digital key that allows the player to confirm that it is authorized to play the shadow content in the content file. The digital key may be included in the metadata accompanying the content file. In another embodiment, the decryption key may be stored in a portion of the shadow content and the portion of the shadow content may be encrypted using a public/private key schema. The portion of the shadow content may be decrypted by the player using a public key supplied by the content provider or other source. In yet another embodiment, the digital key may be transferred to the client device from a remote site, e.g., a remote DRM server, using any secure key delivery mechanism.

In an embodiment, metadata included with the content file may indicate one or more geographical areas where the content may or may not be played whether online or offline (stored locally). The player can check the geographical limitations of the content file when it plays the content file.

2.3 Metadata for Shadow Video

In addition to the shadow video data in the user data section, it is very useful to include an arbitrary amount of metadata as well. Some of these metadata may include:

| Name | Value |
|---|---|
| signature | A unique value that the shadow SDK can check |
| | to identify if the container has a valid shadow |
| | video or not. |
| | For example: |
| | 731edbe4-49c5-4bb1-a24b-2b5a0ce84466 |
| source | This indicates from where the source video was |
| | originated. This is generated when the shadow |
| | container is created or uploaded to a site. |
| | For example any of the following value: |
| | {torrent\|youtube\|device\| |
| | some_campaign_name} |
| originator | This indicates a list of agents responsible for |
| | distributing this content. This can be a definite |
| | number of agents. For example last 8 agents |
| | involved in sharing. |
| | For example: |
| | [vuclip,user1@company.com,user2@company. |
| | com] |

The metadata may also include information relating to users viewing habits for the associated content file. As discussed below, in an embodiment, the metadata may include data that indicates content file sharing and usage history. This data may be entered into the metadata by players installed at client devices. The metadata may include a digital authorization key that a player uses to confirm that it is authorized to play the shadow content. There may also be a sharing key that players share that indicate that the sharing of a particular content file is allowed between users. The metadata may include data indicating where, geographically, the content file is allowed to be viewed. This geographical “fence” can limit where players can play content which gives control to the content provider with respect to market exposure, copyright protection, online and offline viewing, etc. A player may compare the geographical location of the client device with the geographical fence information in order to decide whether a shadow content can be played. If the client device is inside the geographical fence, then the player can play the shadow content. Otherwise, the player may not play the shadow content.

The metadata may include other limiting information, conditions, or rules that the player may use to decide whether the shadow content can be played. The limiting information, conditions, or rules may include any combination of: how many times a user can play the shadow content in an offline manner before the player must be allowed an Internet connectivity, expiration conditions for the shadow content (e.g., shadow content expiration date, maximum number of times the shadow content can be played, playback license expiration date, etc.), the client device type that the shadow content may be played on, etc. The player may modify the metadata in order to update information such as the number of times the shadow content has been played, etc. In the case of the expiration of the shadow content, for example, the player can delete the shadow content from the video file or render the shadow content unreadable.

In an embodiment, it is possible to permanently revoke the client device's playback license for a shadow content. The player can learn about this revocation when communicating with a remote DRM server. If the player learns about a revocation, in addition to rejecting a playback request, the player can also modify the metadata of the content for a permanent revocation. The player can also delete the shadow content from the video file or render the shadow content unreadable.

2.4 Shadow SDK Integration with a Video Player

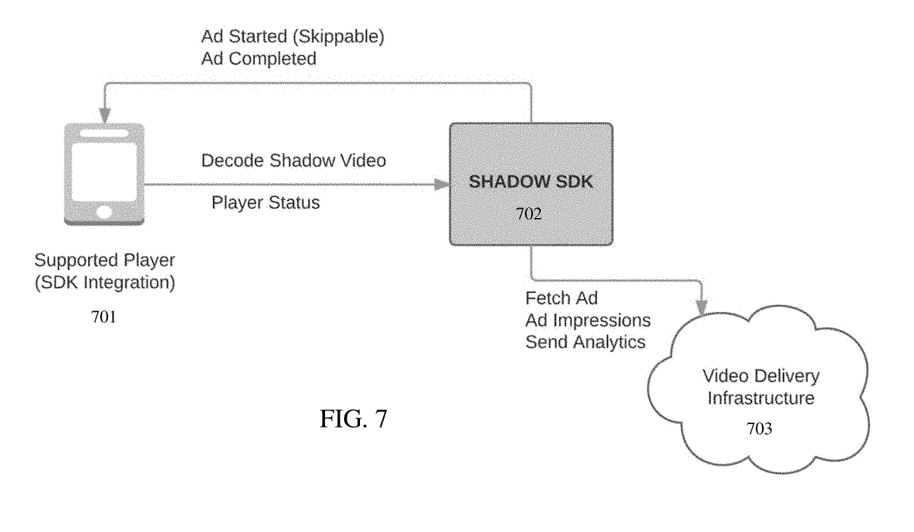

Referring to FIG. 7, a shadow SDK 702 can be included in a supported player 701 that allows the player 701 to locate and play the shadow content. The player 701 identifies that the video file includes a shadow content. The shadow content presence can be detected by parsing the user data in the content file and/or by checking if the content file has a predefined metadata that indicates the presence of the shadow content. In an embodiment, the shadow SDK 702 acts as a streaming server and provides a local streaming URL to the player 701. The local streaming URL starts providing video data from the shadow location of the content file via the shadow SDK 702.

If the user is online, the shadow SDK 702 can also stitch server-side ads into the video metafile. The shadow SDK 702 can retrieve ad impressions from ad servers 106 and can also send analytics events to the content provider server 101 in the video delivery infrastructure 703.

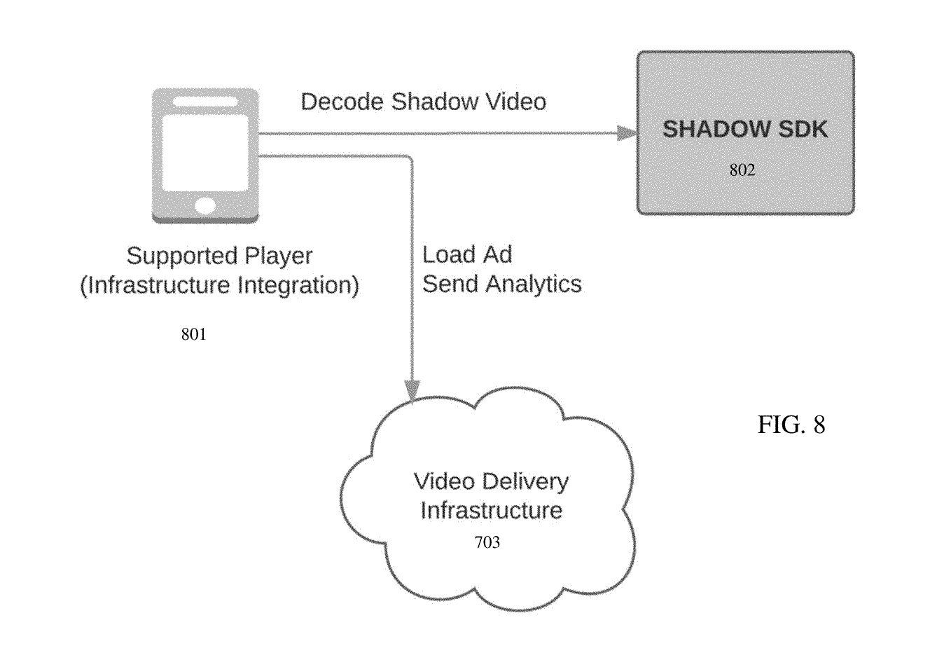

Referring to FIG. 8, the shadow SDK 802 identifies that the content file includes shadow content. The shadow content presence can be detected by parsing the user data in the content file and/or by checking if the content file has a predefined metadata that indicates the presence of the shadow content. In an embodiment, the shadow SDK 802 acts as a streaming server and provides a local streaming URL to the player 801. The local streaming URL starts providing video data from the shadow location of the content file via the shadow SDK 802. In this scenario, the supported player 801 retrieves ads from ad servers 106 and plays ads separately without requiring any support from the shadow SDK 802. The player 801 can also send analytics events to the content provider server 101 in the video delivery infrastructure 703.

2.5 Creating a Shadow Container from a Downloaded Video

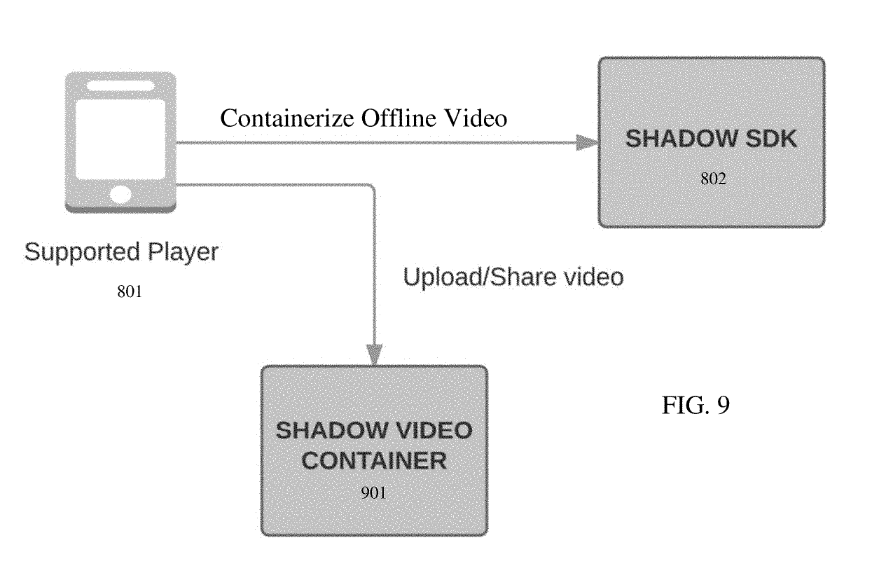

Referring to FIG. 9, in an embodiment, the shadow SDK 802 can create a preview video by creating an MP4 file consisting of few seconds of the downloaded video. The shadow SDK 802 can alternatively use a predefined video or add a predefined video (possibly one that includes the URL of supported players) before or after the preview video. The shadow SDK can then add the entire downloaded video as user data into the same MP4 content file. The shadow SDK 802 then exports the new content file to a public folder from where a user can share the new content file publicly 901, possibly via the player 801.

2.6 P2P Sharing

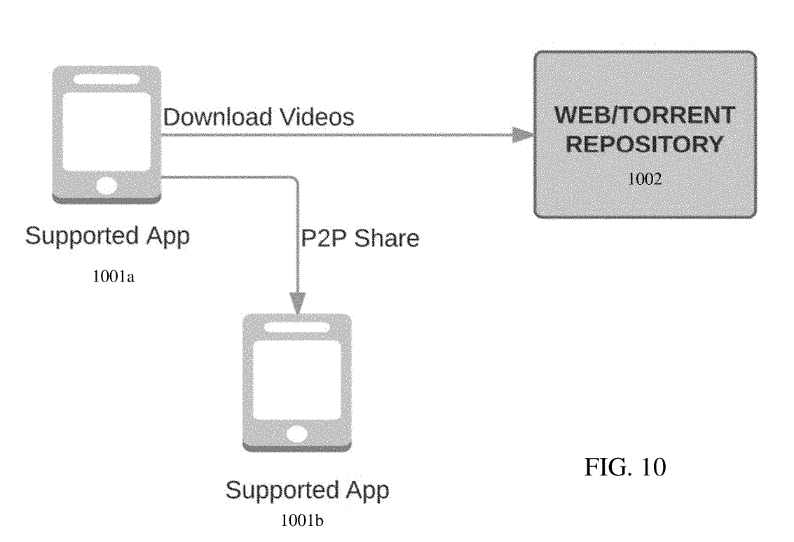

Referring to FIG. 10, a user via a supported app 1001a can directly share a content file directly to other devices 1001b or via a remote server/torrent site 1002. The distribution of the content between peers can be tracked when the content is shared and/or played. In an embodiment, the user may share content files via the specialized player. Whenever a user shares the content file, metadata that is part of the content file is updated to indicate that the user shared the content file and the user that received the content file. As the content file is shared among multiple users, the content file will have the chain of users that it was shared among recorded in its metadata. Other information related to the sharing may also be recorded in the metadata, e.g., the date and time when the sharing occurred, the location of the user when the content file was shared or played, the client device type, other information related to the client device, the social networking service used for sharing, type of communication medium used (e.g., Bluetooth, wifi, cellular, etc.), etc. When the sharing occurs or when the content file is played, the specialized players installed on the client devices can report back to the content provider server 101 the metadata information for the content file. The content provider server 101 can create reports that show the analytic data associated with the metadata for the content file or a plurality of content files. This gives the content provider information that allows the content provider to track the distribution, viewership, and use of their content files.

In an embodiment, users may be tracked as to how many times the user shares content files. A reward system may be implemented that encourages users to share content from the content provider. Users may be rewarded based on the user's frequency of sharing with, for example, free content, free subscriptions, etc. Users can be notified of any rewards via the specialized player, email, text message, etc.

2.7 Online Shadowing

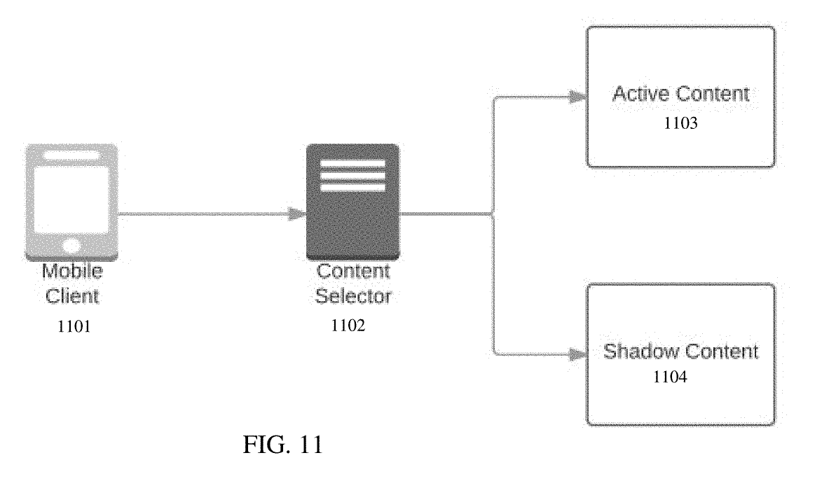

Referring to FIG. 11, online shadowing can be supported. This approach is useful when an end user obtains a direct video link (e.g., DRM protected, etc.) and attempts to play the video content using an unsupported player. In an embodiment, a content provider server 101 maintains two versions of each streaming video content, one version is meant for unsupported players and the other version for supported players. A supported player can add a special HTTP header in its request for retrieving the streaming URL, for example a mobile device player 1101 sends a content request token:

X-VIU-PLAYTOKEN : f9879d16-957c-468f-83ba-72433927be7e

The content request token is sent through a content selector 1102 (e.g., a special application server, a proxy server, etc.). The content selector 1102 may reside in the content provider server 101, at a third party server 102, or installed on the mobile device 1101. The content selector 1102 examines the request and checks for the presence of the special token in the HTTP header. If the header exists, the content selector 1102 redirects the request to the shadow content file 1104. If the header does not exist, the content selector 1102 redirects the request to the active content file 1103. Similar to the downloaded content discussed above, an active streaming content file can display a preview of the shadow content and how to obtain a supported player.

2.8 Shadow Applications

In an embodiment, a standard format content file may be used for carrying application programs, as discussed above, the container can be implemented using a standard format, e.g., MP4, MP3, 3GP, AVI, MKV, etc. Note that, although video formats are discussed in the following, any audio, textual, presentation, multimedia, etc., format may be used in alternate embodiments. The application program may be added to the content file in the same manner as discussed above with reference to FIG. 3. The active video is added to the content file 300 in a typical video data area 301 and the application program is added to the content file 302 after the active video 301. The application program may be installed using a specialized installer, much like the specialized player discussed herein. In an example, the application program is a video game. The active video may be a teaser for the game that gives the user a preview of the game and instructs the user as to how to obtain the specialized installer in order to install the game onto the client device. The specialized installer may index into the content file to retrieve the game using a pointer that may be included in metadata for the content or may jump to the game using any other addressing scheme. The specialized installer then installs the game onto the client device.

In another embodiment, as discussed with respect to FIG. 4, the game is added to the content file 400 in the user data area 401. The specialized installer can refer to the udta area of the content file and retrieve the game for installation.

In yet another embodiment, the game may be an executable file where the installer would pass control to the game executable without installing the game onto the client device.

Further, an embodiment can include a link to the application program in the content file. As discussed with reference to FIG. 5, the active video is added to the content file 500 in the typical area 501 and a link (e.g., URL, etc.) to the application program 502 is added after the active video 501. The specialized installer may then use the link 502 to guide the user to a site where the application program may be accessed. In the game example, the user could be given access to an online game portal or an online game web page.

Alternatively, as discussed with reference to FIG. 6, the application program is added to the content file 600 in the user data area 601. The specialized installer can refer to the udta area of the content file to retrieve the link to guide the user to a site where the application program may be accessed.

2.8.1 Automatic Extraction

In an embodiment, an extraction program may be installed on a client device where the extraction program can automatically decide the actions to take in order to either install or access the shadow content or application program contained or referenced within the content file. The extraction program may be executed by the user and the user directs the extraction program to the content file.

The extraction program finds and reads the shadow content in the content file and analyzes the shadow content to determine whether the shadow content is a video file, audio file, text file, application program, installer program, URL, etc. The extraction program then performs the appropriate actions base on the determination of the what the shadow content is. For example, if the shadow content is an application program, the extraction program will install the application program in the client device and pass execution to the application program.

In another example, the extraction program may identify the shadow content as a video file and then reference the metadata or active content for the location of the player. The extraction program may then retrieve the player from the appropriate location, install the player onto the client device, and pass execution to the player. The player then accesses the shadow content and plays the video.

In yet another example, the extraction program may identify the shadow content as a text file and then reference the metadata or active content for the location of the viewer. The extraction program may then retrieve the viewer from the appropriate location, install the viewer onto the client device, and pass execution to the viewer. The viewer then accesses the shadow content and displays the text.

2.9 Monetizing Shadow Content

Shadow content may be monetized in many ways. In an embodiment, using the video example, the active video may be a beginning portion of the original video and the shadow video may be the remaining portion of the original video that continues from the end of the active video. The user can pay a fee to the content provider for the player to play the shadow video.

In another embodiment, the active video may be a low quality version of a video file while the shadow video is a high definition version of the video file. The user can pay a fee to the content provider for the player to play the shadow video.

In yet another embodiment, the active video may be a normal version of a video file while the shadow video is a director's cut version of the video file. The user can pay a fee to the content provider for the player to play the shadow video.

In the gaming example discussed above, the user may pay a fee to the content provider to play the game. The payment may be collected in game or prior to the game being played either online or prior to loading or installing the game onto the user's client device.

In other embodiments, the active content may be a preview or teaser of the shadow content as discussed above. The user can pay a fee to the content provider for the viewer or player to access the shadow video.

In an audio example, the active content may contain a sample of one or more tracks of an album and the shadow content may contain the complete album. The user can pay a fee to the content provider for a player to play the album in the shadow content.

Advertisements may also be used to monetize the shadow content. The player installed on the client device has the ability to communicate directly with an ad server 106. This allows the content provider to control when a player displays an ad. The player may bookend shadow content with an ad played before the shadow content is played and then after the shadow content is played. The player may also play ads during the playing of the shadow content. The content provider can indicate to the player when to insert ads while playing the shadow content via real time messages to the player. Such messages may indicate a specific ad and where the ad is to be obtained.

In an embodiment, an apparatus comprises a processor and is configured to perform any of the foregoing methods.

In an embodiment, a non-transitory computer readable storage medium, storing software instructions, which when executed by one or more processors cause performance of any of the foregoing methods.

Note that, although separate embodiments are discussed herein, any combination of embodiments and/or partial embodiments discussed herein may be combined to form further embodiments.

### 3.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

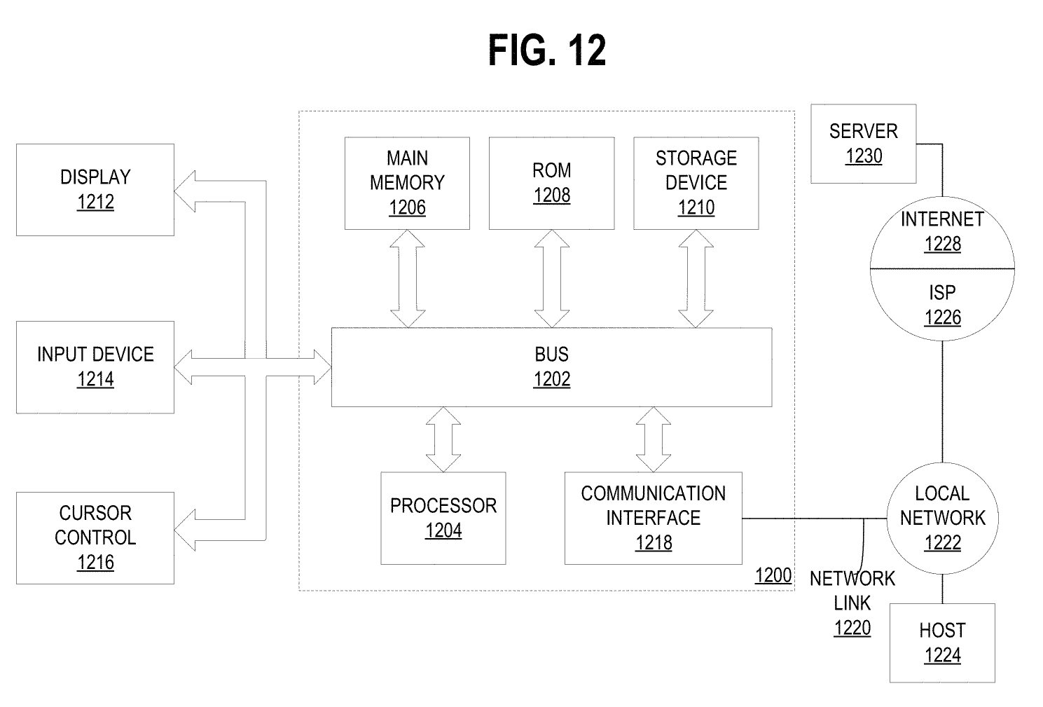

FIG. 12 is a block diagram that illustrates a computer system 1200 utilized in implementing the above-described techniques, according to an embodiment. Computer system 1200 may be, for example, a desktop computing device, laptop computing device, tablet, smartphone, server appliance, computing mainframe, multimedia device, handheld device, networking apparatus, or any other suitable device.

Computer system 1200 includes one or more busses 1202 or other communication mechanism for communicating information, and one or more hardware processors 1204 coupled with busses 1202 for processing information. Hardware processors 1204 may be, for example, a general purpose microprocessor. Busses 1202 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 1200 also includes a main memory 1206, such as a random access memory (RAM) or other dynamic or volatile storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes one or more read only memories (ROM) 1208 or other static storage devices coupled to bus 1202 for storing static information and instructions for processor 1204. One or more storage devices 1210, such as a solid-state drive (SSD), magnetic disk, optical disk, or other suitable non-volatile storage device, is provided and coupled to bus 1202 for storing information and instructions.

Computer system 1200 may be coupled via bus 1202 to one or more displays 1212 for presenting information to a computer user. For instance, computer system 1200 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 1212 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 1212.

In an embodiment, output to display 1212 may be accelerated by one or more graphics processing unit (GPUs) in computer system 1200. A GPU may be, for example, a highly parallelized, multi-core floating point processing unit highly optimized to perform computing operations related to the display of graphics data, 3D data, and/or multimedia. In addition to computing image and/or video data directly for output to display 1212, a GPU may also be used to render imagery or other video data off-screen, and read that data back into a program for off-screen image processing with very high performance. Various other computing tasks may be off-loaded from the processor 1204 to the GPU.

One or more input devices 1214 are coupled to bus 1202 for communicating information and command selections to processor 1204. One example of an input device 1214 is a keyboard, including alphanumeric and other keys. Another type of user input device 1214 is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane. Yet other examples of suitable input devices 1214 include a touch-screen panel affixed to a display 1212, cameras, microphones, accelerometers, motion detectors, and/or other sensors. In an embodiment, a network-based input device 1214 may be utilized. In such an embodiment, user input and/or other information or commands may be relayed via routers and/or switches on a Local Area Network (LAN) or other suitable shared network, or via a peer-to-peer network, from the input device 1214 to a network link 1220 on the computer system 1200.

A computer system 1200 may implement techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 1200 can receive the data on the network and demodulate the signal to decode the transmitted instructions. Appropriate circuitry can then place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

A computer system 1200 may also include, in an embodiment, one or more communication interfaces 1218 coupled to bus 1202. A communication interface 1218 provides a data communication coupling, typically two-way, to a network link 1220 that is connected to a local network 1222. For example, a communication interface 1218 may be an integrated services digital network (ISDN) card, cable modem, satellite modem, or a modem to provide a data communication connection to a corresponding type of telephone line. As another example, the one or more communication interfaces 1218 may include a local area network (LAN) card to provide a data communication connection to a compatible LAN. As yet another example, the one or more communication interfaces 1218 may include a wireless network interface controller, such as a 802.11-based controller, Bluetooth controller, Long Term Evolution (LTE) modem, and/or other types of wireless interfaces. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through local network 1222 to a host computer 1224 or to data equipment operated by a Service Provider 1226. Service Provider 1226, which may for example be an Internet Service Provider (ISP), in turn provides data communication services through a wide area network, such as the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

In an embodiment, computer system 1200 can send messages and receive data, including program code and/or other types of instructions, through the network(s), network link 1220, and communication interface 1218. In the Internet example, a server 1230 might transmit a requested code for an application program through Internet 1228, ISP 1226, local network 1222 and communication interface 1218. The received code may be executed by processor 1204 as it is received, and/or stored in storage device 1210, or other non-volatile storage for later execution. As another example, information received via a network link 1220 may be interpreted and/or processed by a software component of the computer system 1200, such as a web browser, application, or server, which in turn issues instructions based thereon to a processor 1204, possibly via an operating system and/or other intermediate layers of software components.

In an embodiment, some or all of the systems described herein may be or comprise server computer systems, including one or more computer systems 1200 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 4.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
creating a video file having a first content area containing a first video and a second content area containing a second video, the video file formatted according to a first video standard;
encrypting at least a portion of the second video in the second content area, the second video is not viewable using a first video standard player, and the second video is viewable using a specialized video player;
wherein video content in the first content area includes instructions that, when played by the first video standard player, instruct a user on how to download the specialized video player that can access the second video;
storing the video file along with a plurality of video files;
distributing one or more stored video files to client devices.

2. The method of claim 1, further comprising:
receiving a request from a client device for a specialized video player;
sending the specialized video player to the client device.

3. The method of claim 1, further comprising:
including metadata in the video file that includes at least a validation signature and a source of the video file.

4. The method of claim 1, further comprising:
including metadata in the video file;
wherein a specialized video player installed on a client device adds user sharing information to the metadata.

5. The method of claim 1, further comprising:
including metadata in the video file that includes geographical information indicating what geographical areas that the second video may be viewed in;
wherein a specialized video player installed on a client device refers to the geographical information prior to playing the second video in the video file.

6. The method of claim 1, further comprising:
including metadata in the video file that includes conditional information relating to the second video in the video file;
wherein a specialized video player installed on a client device refers to the conditional information to decide whether to allow or deny playback of the second video in the video file.

7. The method of claim 1, wherein the first video is a trailer or preview related to the second video.

8. The method of claim 1, wherein the first video is a standard definition video and the second video is a high-definition version of the standard definition video.

9. The method of claim 1, wherein the first video is a first portion of an original video and the second video is second portion of the original video.

10. A non-transitory computer readable medium storing a program of instructions that is executable by a device to perform a method, the method comprising:
creating a video file having a first content area containing a first video and a second content area containing a second video, the video file formatted according to a first video standard;
encrypting at least a portion of the second video in the second content area, the second video is not viewable using a first video standard player, and the second video is viewable using a specialized video player;
wherein video content in the first content area includes instructions that, when played by the first video standard player, instruct a user on how to download the specialized video player that can access the second video;
storing the video file along with a plurality of video files;
distributing one or more stored video files to client devices.

11. The non-transitory computer readable medium of claim 10, further comprising:
receiving a request from a client device for a specialized video player;
sending the specialized video player to the client device.

12. The non-transitory computer readable medium of claim 10, further comprising:
including metadata in the video file;
wherein a specialized video player installed on a client device adds user sharing information to the metadata.

13. The non-transitory computer readable medium of claim 10, wherein the first video is a trailer or preview related to the second video.

14. The non-transitory computer readable medium of claim 10, wherein the first video is a standard definition video and the second video is a high-definition version of the standard definition video.

15. The non-transitory computer readable medium of claim 10, wherein the first video is a first portion of an original video and the second video is second portion of the original video.

16. An apparatus, comprising:
a subsystem, implemented at least partially in hardware, that creates a video file having a first content area containing a first video and a second content area containing a second video, the video file formatted according to a first video standard;
a subsystem, implemented at least partially in hardware, that encrypts at least a portion of the second video in the second content area, the second video is not viewable using a first video standard player, and the second video is viewable using a specialized video player;
wherein video content in the first content area includes instructions that, when played by the first video standard player, instruct a user on how to download the specialized video player that can access the second video;
a subsystem, implemented at least partially in hardware, that stores the video file along with a plurality of video files;
a subsystem, implemented at least partially in hardware, that distributes one or more stored video files to client devices.

17. The apparatus of claim 16, further comprising:
a subsystem, implemented at least partially in hardware, that receives a request from a client device for a specialized video player;
a subsystem, implemented at least partially in hardware, that sends the specialized video player to the client device.

18. The apparatus of claim 16, further comprising:
a subsystem, implemented at least partially in hardware, that includes metadata in the video file;
wherein a specialized video player installed on a client device adds user sharing information to the metadata.

19. The apparatus of claim 16, wherein the first video is a standard definition video and the second video is a high-definition version of the standard definition video.

20. The apparatus of claim 16, wherein the first video is a first portion of an original video and the second video is second portion of the original video.
